(19) United States
(12) Patent Application Publication
(10) Pub. No.: US 2005/0251774 A1
(43) Pub. Date: Nov. 10, 2005

(54) Circuit design property storage and manipulation

(76) Inventors: Gaurav R. Shah, Caldwell, ID (US); Denise S. Man, Fort Collins, CO (US)

Correspondence Address: HEWLETT-PACKARD COMPANY;Intellectual Property Administration, P.O. Box 272400, Fort Collins, CO, 80527-2400, US

(21) Appl. No.: 11/089,575

(22) Filed: May 7, 2004

(51) Int. Cl. G06F 17/50

(52) U.S. Cl. 716/7; 716/11; 716/18

(57) ABSTRACT

One example embodiment of property data storage includes using row and column names to identify properties to a particular circuit design component. Each of a plurality of columns in a relational database table is named with a property name indicative of a respective one of a plurality of circuit design properties. Another column in the relational database table is named with a property name indicating the column is unassigned to a circuit design property. Rows in the relational database table are named with respective names of the plurality of design components. When a circuit design component has a property indicated by one of the property names of the columns, a data value indicative of the circuit design component having the property is stored in the table entry at the column having the one of the property names and at the row having the name of the circuit design component. When a circuit design component does not have a property indicated by one of the property names of the columns, a data value indicative of the circuit design component having a non-assigned property is stored in the table entry at the column having the property name indicating the column is unassigned to a circuit design property and at the row having the name of the circuit design component.

### BACKGROUND

Circuit designs are generally created and implemented using tools that generate information that is stored in one or more data storage arrangements. This information may be accessed for analysis and testing of the design. For example, circuit recognition and verification are two approaches that involve access to stored design data for a variety of purposes, such as identifying components and connectivity for a design (circuit recognition) and verifying the operation of the design under certain conditions (circuit verification).

Storing circuit design information typically involves storing sufficient information for each design component that identifies characteristics and connectivity for all components in the circuit design. For instance, many typical circuit designs employ a multitude of FETs (field-effect transistors) and NETs (information describing the connectivity of the FETs) that define functional circuits. These FETs and NETs are typically arranged with a hierarchical relationship, with different FETs and NETs being attributed to a multitude of blocks and sub-blocks (or child blocks) that define the circuit design.

In some instances, relatively large and complex circuit designs are implemented and analyzed for one or more of a variety of purposes, such as circuit recognition and verification. As circuit designs become increasingly large and complex, the amount of data storage needed to store information for the circuit designs becomes correspondingly large. For example, many designs involve hundreds of thousands of design components (e.g., FETs and NETs). Information identifying the characteristics of these design components must be stored and made available for access. Many of these characteristics are shared by many different design components, while other characteristics are relatively infrequently used, applying to relatively few design components.

Addressing data storage needs for circuit design and other information has become increasingly challenging.

### SUMMARY

According to an example embodiment of the present invention, property data is stored for a plurality of named circuit design components. Each of a plurality of columns in a relational database table is named with a property name indicative of a respective one of a plurality of circuit design properties. Another column in the relational database table is named with a property name indicating the column is unassigned to a circuit design property. Rows in the relational database table are named with respective names of the plurality of design components. Property information associated with the plurality of circuit design components is stored in entries of the relational database table using the named columns and rows. For instance, when a circuit design component has a property indicated by one of the property names of the columns, a data value indicative of the circuit design component having the property is stored in the table entry at the column having the one of the property names and at the row having the name of the circuit design component. Similarly, when a circuit design component does not have a property indicated by one of the property names of the columns, a data value indicative of the circuit design component having a non-assigned property is stored in the table entry at the column having the property name indicating the column is unassigned to a circuit design property and at the row having the name of the circuit design component.

It will be appreciated that various other embodiments are set forth in the Detailed Description and Claims that follow.

### BRIEF DESCRIPTION OF THE DRAWINGS

FIG. 1 is a flow diagram for an approach to storing circuit design information, according to an example embodiment of the present invention;

FIG. 1A is another flow diagram for an approach to storing circuit design information, according to another example embodiment of the present invention;

FIGS. 2A and 2B show a circuit design data storage arrangement and approach, according to another example embodiment of the present invention, wherein:

FIG. 2A shows a block diagram with various columns for storing bits relating to frequently-used circuit design properties for a variety of circuit components; and

FIG. 2B shows a table for storing infrequently-used circuit design properties for a variety of circuit components; and

FIG. 3 shows a circuit design storage arrangement, according to another example embodiment of the present invention.

### DETAILED DESCRIPTION

According to an example embodiment of the present invention, circuit design data is stored as a function of the frequency at which the data is used to characterize the design. Frequently used information for each component in the design is stored as individual bits in one or more of a plurality of characterization columns for a particular row to which the design component is assigned. Each of the columns is labeled with a particular frequently used property that characterizes design components (e.g., wherein several design components share the same property). These properties may, for example, pertain to FET, NET or structural characteristics for a particular design. The value in each column (e.g., “0” “1” or “NULL”) for a particular row is indicative of whether the design component having data stored in that particular row is characterized by the property that the column is labeled with.

Infrequently used properties for a particular design component are stored and referenced using a series of bits (i.e., a string) that identifies the design component to which the property applies as well as information identifying the infrequently used property itself. For instance, the identification of a particular design component, property and value for the property can all be stored using a series of bits. This series of bits collectively takes up less space in memory relative to, for example, an entire column as used for storing frequently used properties. With this combined single-bit and bit series design data storage approach, frequently and infrequently used properties are stored in different, relatively efficient manners. Frequently used properties can be stored using a single bit, while infrequently used designs do not expend an entire column.

In another implementation, a column among the columns labeled with a frequently used property is used to identify a particular design component as having an infrequently used property. When this column is true (e.g., has a “1” stored for a particular design component), a second table used to store infrequently used property information is parsed to identify the particular infrequently used property (or properties) assigned to the design component. For example, when a user's program (application program) accesses information for a design component having a “1” in an “infrequently used property” column, a routine can be called to access the second table. The second table is parsed for the particular design component and, when found, a property associated therewith is identified.

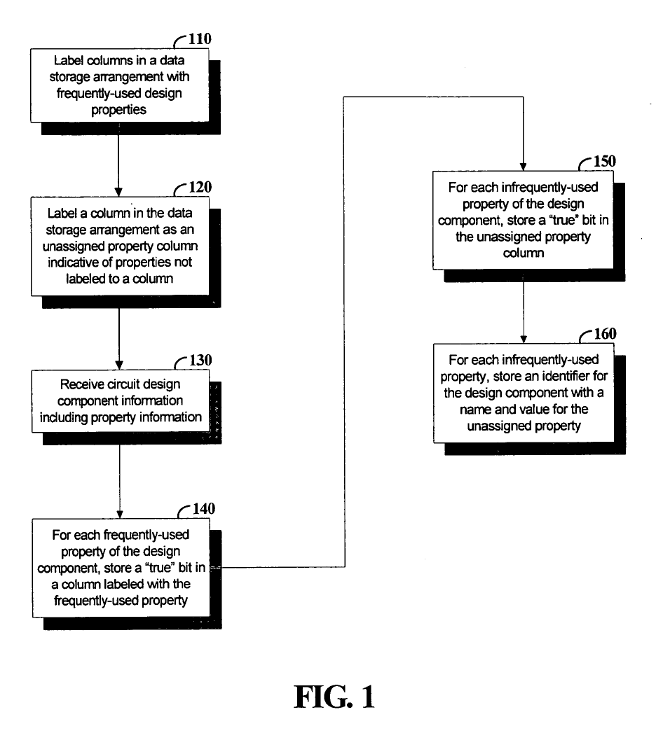

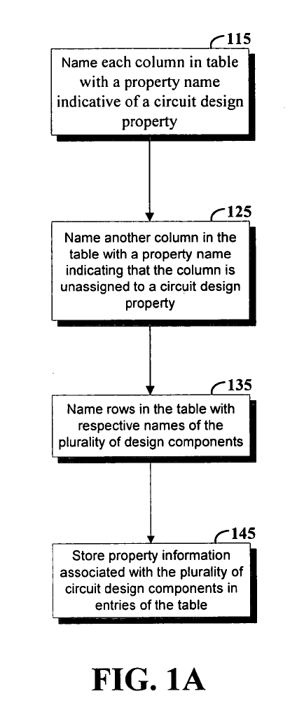

Turning now to the figures, FIG. 1 shows a flow diagram for an approach to processing and storing circuit design information, according to another example embodiment of the present invention. At block 110, columns in a data storage arrangement are labeled with frequently used design properties, with data stored in those columns being attributable to the design property that the column is labeled with and its applicability to a particular circuit design component associated with the data. At block 120, one of the columns is labeled as an “unassigned property” column, with data stored in the unassigned property column being attributable to a design property (i.e., an infrequently used property) not labeled to a column. Specifically, positive data (e.g., a logically “true” bit such as a “1” ) stored in the unassigned property column for a particular circuit component is used to indicate that property information for the circuit component is stored in a different location.

Circuit design component information with associated characterizing property information is received at block 130. If the circuit design component is characterized by a frequently-used property at block 140, positive data (e.g., a “true” bit) is stored in a column labeled with the frequently-used property. Positive data is similarly stored for each frequently-used property characterizing the design component. If the design component is characterized by an infrequently-used property at block 150, positive data is stored in the unassigned property column. In addition, for each infrequently-used property characterizing the circuit design, information for the design component including an identifier for the design component and a name and value for the unassigned property is stored at block 160 using, e.g., a bit string or strings. In various implementations, this identifier further includes additional information, such as information relating to a classification or key (with examples discussed further below) or other information useful in retrieving the identifier.

In another embodiment, the frequency at which design properties are used by different circuit design components is monitored and the storage of circuit design component data is controlled as a function of the monitoring. In one implementation (and referring again to FIG. 1), when a selected number of circuit designs are characterized by a particular design property, that property can be labeled to a column in the data storage arrangement in block 110. This selected number may be chosen, for example, as a function of a data storage efficiency relationship between the above-discussed approaches involving the column dedication approach of block 110 or name and value approach of block 160. When a particular design property takes up less room using a column dedication-type storage approach as discussed with block 110 (e.g., many design components share the property), relative to the name and value approach of block 160, a column is dedicated to the property. Correspondingly, when the name and value approach of block 160 uses less space for storing a particular design property (e.g., few design components share the property), relative to the column dedication approach of block 110, the approach discussed with block 160 is used to store the property information.

In another implementation, design properties are labeled to a column at block 110 as a function of the above-discussed frequency monitoring identifying the most-frequently-used design properties, with all available columns being labeled accordingly as discussed in connection with block 110 above. For instance, where 80 columns are available, the 80 most-frequently-used design properties are stored in these columns. Design properties not characterized as being most-frequently-used are stored at block 160 as discussed above.

In some instances, design properties characterized as frequently used and labeled to a column as discussed in connection with block 110 become less frequently used over time. In these instances, the design properties are optionally removed as a label to a column and stored as discussed in connection with block 160 along with information for any corresponding design components having the properties being removed. Similarly, design properties characterized as infrequently used and stored as discussed in connection with block 160 become more frequently used. In these instances, the design properties stored with the name and value approach discussed in connection with block 160 are labeled to a column, with information being stored in the column to associate the property with particular design components.

In one implementation, the data discussed in connection with FIG. 1 is stored in an XML (extensible markup language) type of data storage arrangement. In this implementation, an integer is stored in a manner consistent with XML-type data storage using, for example, 32 bits. Each bit is stored in a particular labeled column in the data storage arrangement. When a bit is to be changed, a bitwise OR operation is carried out to switch a particular bit of the integer between a “true” (1) and “false” (0) state. The “NULL” state is thus typically unused, with each column having either a “1” or “0” stored therein. The bitwise OR operation (a binary “|” operator) is carried out with “expr1 | expr2,” with “expr1” and “expr2” being expressions and with the binary | operator predefined for integral types and used to compute the bitwise OR of its operands (here, expr1 and expr2).

A list of integer values is predefined for all columns having their corresponding bits turned on. For instance, if a bit “1” stands for “property_1,” a “property 1” integer is defined as a value “1.” Similarly, if “property_4,” is represented by bit “4” we define a “property_4” integer is defined as a value 8. The value numbers can be calculated using simple bit arithmetic. In this regard, when a component has property_4, a bitwise OR of the component's property with integral value property4 is performed with the component property (comp_property)=comp_property | property4. This bitwise OR operation turns the fourth bit of the component property to a true value in the XML data storage arrangement.

FIG. 1A is a flow diagram for an approach to storing property data for a plurality of named circuit design components, according to another example embodiment of the present invention. At block 115, each column in a relational database table is named with a property name indicative of a respective one of a plurality of circuit design properties used to characterize at least one of the circuit design components. At block 125, another column in the relational database table is named with a property name indicating that the column is unassigned to a circuit design property. At block 135, rows in the relational database table are named with respective names of the plurality of design components. Property information associated with the plurality of circuit design components is stored in entries of the relational database table at block 145.

The storage of property information at block 145 is carried out as a function of a correspondence between a circuit design component property and a named column in the relational database table, as discussed in connection with block 115. In response to a circuit design component having a property indicated by one of the property names of the columns, a data value indicative of the circuit design component having the property is stored in the table entry at the column having the one of the property names and at the row having the name of the circuit design component. In response to a circuit design component not having a property indicated by one of the property names of the columns, a data value indicative of the circuit design component having a non-assigned property is stored in the table entry at the column having the property name indicating the column is unassigned to a circuit design property and at the row having the name of the circuit design component.

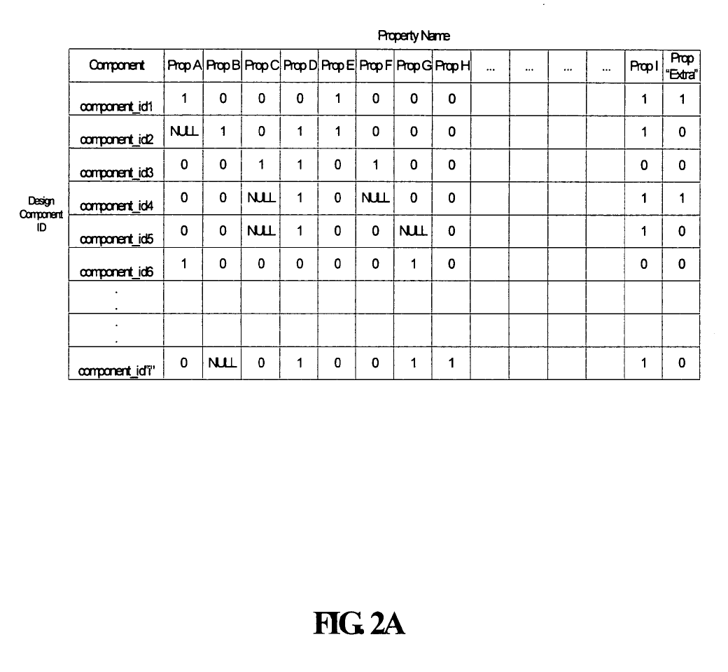

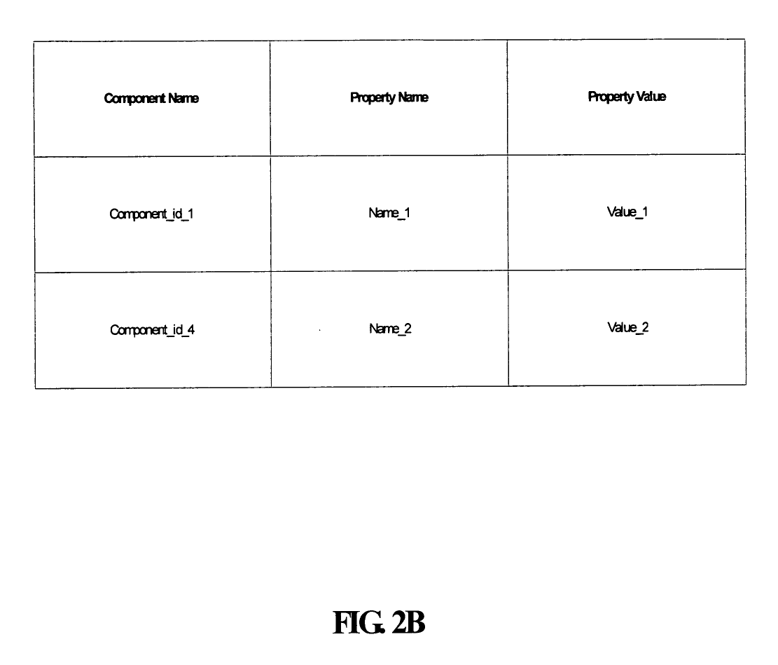

FIGS. 2A and 2B show circuit design data storage approaches, according to other example embodiments of the present invention. FIG. 2A shows an approach for storing frequently-used circuit design property information and FIG. 2B shows an approach for storing infrequently-used circuit design property information. The approaches shown in FIGS. 2A and 2B may be implemented, for example, in connection with one or more of the example embodiments discussed above. The tables shown in each of FIGS. 2A and 2B can be implemented using a relational database (i.e., a database that stores all of its data inside tables (a set of rows and columns)). Operations on data in such a relational database are performed on the tables themselves and/or in connection with the production of other tables. In addition, each of the embodiments discussed in connection with FIGS. 2A and/or 2B may be separately implemented or implemented in one or more various combinations with one another.

Referring to FIG. 2A, various columns are implemented for storing bits relating to frequently-used circuit design properties for a variety of circuit design components. A series of properties are labeled to columns, shown by way of example with properties “A” through “i” (“i” representing an arbitrary number of property columns), as well as an “Extra” property column. Columns “A” through “i” are used to store frequently-used properties (i.e., those properties used by a sufficient number of design components to make their use of an entire column desirable for efficiency and/or other purposes). The “Extra” property column is used for indicating that a particular design component has a property not labeled to a column. These extra properties may include, for example, properties discussed above as infrequently-used properties.

Information for a plurality of circuit design components is stored in a series of rows, each row being labeled with identification information for a particular design component. By way of example, design components are identified with column names “component_id_1” through “component_id_n,” (with “n” representing an arbitrary number of component identification names). Property information for each particular design component is stored as a function of a single bit in a property-labeled column. The state of the bit (or lack thereof) is used to characterize a relationship between a particular property and a design component.

Some of the rows and columns are shown with “true” (1) and “false (0) bits, with others being neither “true” nor “false” (NULL). This approach with “true,” “false” and “NULL” is used either to positively identify a relationship (true or false) between a particular design component and a property, or to represent a lack of any such relationship (NULL). Locations labeled with “NULL” are implemented in various instances where it is desirable to use less memory (i.e., a “NULL” entry taking up no memory relative to, for example, a “1” or a “0” bit).

Using the design component identified with “component_id_1” as an example, the respective columns labeled with properties A, E, i and Extra each have a “true” bit associated with the row identified by “component_id_1.” In this regard, the design component identified with “component_id_1” is associated with properties A, E and i, as well as an extra property that is stored in another location. This extra property may typically be associated with an infrequently-used property as discussed above and stored using an approach that involves, for example, the use of a series of bits to identify the design component and various property characteristics. This approach involving the storage of an infrequently used property as a series of bits, relative to a single bit in a column, may be used, for example, where dedication of an entire column to a particular property is undesirable. In addition, the storage of information in connection with design components having such an extra property may be implemented, for example, as shown in and discussed below in connection with FIG. 2B.

FIG. 2B shows an arrangement and approach for storing infrequently-used property information for a variety of design components in a data table. Three columns are shown, with the first column including information that identifies the name of a particular component, the second column including information that identifies a particular property and the third column including information for a value of the property. This information is stored as a bit string having characteristics relating to the column types. By way of example, FIG. 2B shows information for two design components, component_id_1 and component_id_4, indicated in FIG. 2A as having an “Extra” property.

Information in each of the three columns may be stored using a variety of approaches. For example, the first column may identify a particular design component using a unique integer assigned to the design component. This integer may point, for example, to a particular location in another storage location, such as that shown in FIG. 2A, without necessarily storing the name of the design component in FIG. 2B. For instance, an integer in the second row of the first column may be used to point to “component_id_1” in FIG. 2A. Integers can be assigned to particular design components using, for example, approaches involving the selection of random or successive integers that are assigned to new design components as they are added to the table.

Information for the property in the second column can be stored using a variable character type approach, with a bit string (e.g., characterized as “property_1”) including sufficient information to identify the property. The bit string takes up the amount of bit space it needs, up to a limited number of bits, with bits over the limited number being truncated. Similarly, property value information in the third column may also be stored using a bit string, with the string identifying a particular value associated with the property in the second column (of the same row). Again referring to the second row with “component_id_1” in the first column, a property “property_1” having a value “value_1” is correspondingly associated with the component name “component_id_1” via information in the first column.

Using the table shown in FIG. 2B and approaches similar to those discussed above, a multitude of names (with associated data types) and information for the names can be stored, with the shown data being representative of selected examples. Tables for a design block, structure component, FET component, NET component or association information can be implemented using a similar approach. For instance, when information for a particular design component, such as a FET, is to be retrieved, a block table including information identifying a design block is parsed to obtain a design block ID. An association table related to the block ID is then parsed to retrieve identification (e.g., a FET ID) for the design component. The design component identification is then used to identify a component table to go to for retrieving the information (e.g., a table identifying the particular design component, as shown in FIG. 2B). Relationships between the tables are identified using, e.g., keys stored in the tables that include information such as a block ID to which an association, FET or NET table relates.

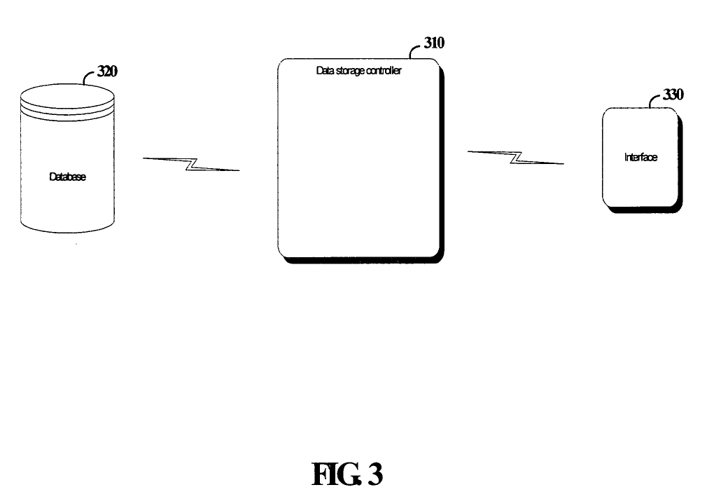

FIG. 3 shows a circuit design storage arrangement 300, according to another example embodiment of the present invention. The storage arrangement 300 is configured and arranged to store circuit design data as a function of the frequency that the data is used and of corresponding database use efficiency. In this regard, the storage arrangement 300 may be implemented using one or more of the approaches discussed above.

The storage arrangement 300 includes a data storage controller 310 configured with a database 320 (e.g., a relational database configured for structured query language (SQL) storage) for storing circuit design information. A user interface 330 is further configured for interfacing between a user (i.e., human) and the data storage controller for facilitating the storage and retrieval of circuit design data from the database 320. When design component data including name and property information is input via the interface 330, the data storage controller 310 stores the information in the database 320. The data storage controller 310 stores the design component name in a column (e.g., as shown in FIG. 2A) with each frequently-used property of the design component characterized by a bit stored in a column labeled with the frequently-used property. For each property of the design component not corresponding to a labeled column (i.e., infrequently used designs), the data storage controller 310 stores the design component name, property name and related property value information is stored in a separate table. Information for such infrequently-used properties may be stored, for example, as a bit string in a manner similar to that shown in FIG. 2B and discussed above.

Once the design data is stored at the database 320, it can be accessed using identification and other information to retrieve specific information about the design as discussed above. For example, when an application program interface (API) call including block name and path information is received at the interface 330, the interface communicates block name and path information to the data storage controller 310.

In another example embodiment of the present invention, one or more of the approaches to circuit design property storage and manipulation discussed herein are implemented for circuit recognition type applications. When designs are retrieved for recognition-type (and circuit verification-type) purposes, one or more of these approaches can be implemented for storing and retrieving data. For general information regarding circuit recognition and for specific information regarding various implementations to which the present invention is applicable, reference may be made to U.S. patent application Ser. No. ______(200209788-1/HPCO.131PA) entitled “Circuit Design Interface” and filed on Feb. 24, 2004, which is fully incorporated herein by reference.

Those skilled in the art will appreciate that various alternative computing arrangements would be suitable for hosting the approaches of the different embodiments of the present invention. In addition, the approaches may be implemented via a variety of computer-readable media or delivery channels such as magnetic or optical disks or tapes, electronic storage devices, or as application services over a network.

The present invention is believed to be applicable to a variety of data storage arrangements and approaches and has been found to be particularly applicable and beneficial for use with circuit design data storage for use with circuit recognition and verification-type implementations. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

1. A method for storing property data for a plurality of named circuit design components, the method comprising:
naming each of a plurality of columns in a relational database table with a property name indicative of a respective one of a plurality of circuit design properties used to characterize at least one of the circuit design components;
naming another column in the relational database table with a property name indicating the column is unassigned to a circuit design property;
naming rows in the relational database table with respective names of the plurality of design components; and
storing property information associated with the plurality of circuit design components in entries of the relational database table, wherein storing includes,
in response to a circuit design component having a property indicated by one of the property names of the columns, storing a data value indicative of the circuit design component having the property, in the table entry at the column having the one of the property names and at the row having the name of the circuit design component; and
in response to a circuit design component not having a property indicated by one of the property names of the columns, storing a data value indicative of the circuit design component having a non-assigned property, in the table entry at the column having the property name indicating the column is unassigned to a circuit design property and at the row having the name of the circuit design component.

2. The method of claim 1, further comprising, in response to a circuit design component not having a property indicated by one of the property names of the columns, storing data representing the circuit design component name and the property name in a row of a second database table.

3. The method of claim 2, wherein storing data representing the circuit design component name and the property name in a row of a second database table includes storing a bit string identifying the circuit design component name in the row of the second database table.

4. The method of claim 3, wherein storing a bit string identifying the circuit design component name includes storing a bit string that references the row, of the relational database, named with the circuit design component.

5. The method of claim 2, wherein storing data representing the circuit design component name and the property name in a row of a second database table includes storing a bit string identifying the property name in the row of the second database table.

6. The method of claim 2, further comprising storing data representing a value for the property in the row of the second database table.

7. The method of claim 2, wherein storing data representing the circuit design component name and the property name in a row of a second database table includes storing the circuit design component name and the property name in a second database table that is separate from the relational database table.

8. The method of claim 1, wherein storing a data value indicative of the circuit design component having the property includes storing a bit that indicates that the circuit design component has the property, and wherein storing a data value indicative of the circuit design component having a non-assigned property includes storing a bit that indicates that the circuit design component has a non-assigned property.

9. The method of claim 1, further comprising, in response to a circuit design component not having a property indicated by a particular property name of a column, storing a data value indicative of the circuit design component not having the property, in the table entry at the column having the one of the property names and at the row having the name of the circuit design component.

10. The method of claim 9, wherein storing a data value indicative of the circuit design component not having the property includes storing a bit that indicates that the circuit design component does not have the property.

11. The method of claim 9, wherein storing a data value indicative of the circuit design component not having the property includes storing a NULL value.

12. The method of claim 1, further comprising:
monitoring the number of circuit design components having a property named to a column in the relational database; and
removing a property name and all data values from a column as a function of the monitoring.

13. The method of claim 12, wherein removing a property name and all data values from a column as a function of the monitoring includes removing a property name and all data values from a column when the number of circuit design components that have the property indicated by the property name falls below a selected threshold.

14. The method of claim 13, wherein removing a property name and all data values from a column when the number of circuit design components that have the property indicated by the property name falls below a selected threshold includes removing the property name and all data values when storing data representing the name of the property and the circuit design components having the property is more efficient than dedicating an entire column to the named property.

15. The method of claim 1, further comprising:
in response to a circuit design component not having a property indicated by one of the property names of the columns, storing data representing the circuit design component name and the property name in a row of a second database table;
monitoring the number of circuit design components having a property named to a column in the relational database;
removing a property name and all data values from a column as a function of the monitoring; and
for each circuit design component having a property indicated by the removed property name, storing data representing the circuit design component name and the property name in a row of the second database table.

16. The method of claim 15, further comprising:
monitoring the number of circuit design components having the same property and with data representing the circuit design component name and the property name being stored in a row of the second database table; and
as a function of the monitoring, naming a column in the relational database with said same property and storing a data value indicative of the circuit design components having said same property, in the table entry at the column named with said same property and at respective rows having the name of the circuit design components having said same property, and removing the data representing the circuit design components with said same property from the second database table.

17. The method of claim 1, further comprising retrieving property data for a particular circuit design component by:
in response to a column in a row named with the circuit design component having a data value indicative of the circuit design component having the property named to the column, returning the property name of the column; and
in response to the column with the property name that indicates the column is unassigned to a circuit design property having, in a row named with the circuit design component, a data value indicative of the circuit design component having an unassigned property, accessing a second database table to retrieve property data, unassigned to a column, for the particular design component.

18. A system for storing property data for a plurality of named circuit design components, the system comprising:
a plurality of columns in a relational database table named with property name indicative of a respective one of a plurality of circuit design properties used to characterize at least one of the circuit design components;
another column in the relational database table named with a property name indicating the column is unassigned to a circuit design property;
rows in the relational database table named with respective names of the plurality of design components; and
means for storing property information associated with the plurality of circuit design components in entries of the relational database table, wherein storing includes,
in response to a circuit design component having a property indicated by one of the property names of the columns, storing a data value indicative of the circuit design component having the property, in the table entry at the column having the one of the property names and at the row having the name of the circuit design component; and
in response to a circuit design component not having a property indicated by one of the property names of the columns, storing a data value indicative of the circuit design component having a non-assigned property, in the table entry at the column having the property name indicating the column is unassigned to a circuit design property and at the row having the name of the circuit design component.

19. The system of claim 18, further comprising:
a second database table; and
means, responsive to a circuit design component not having a property indicated by one of the property names of the columns, for storing data representing the circuit design component name and the property name in a row of the second database table.

20. The system of claim 19, further comprising:
a storage controller circuit adapted to monitor the number of circuit design components having a property named to a column in the relational database, to remove a property name and all data values from a column as a function of the monitoring and, for each circuit design component having a property indicated by the removed property name, to store data representing the circuit design component name and the property name in a row of the second database table.

21. The system of claim 20, wherein the storage controller circuit is further adapted to monitor the number of circuit design components having the same property and with data representing the circuit design component name and the property name being stored in a row of the second database table and, as a function of the monitoring, name a column in the relational database with said same property and store a data value indicative of the circuit design components having said same property, in the table entry at the column named with said same property and at respective rows having the name of the circuit design components having said same property, and remove the data representing the circuit design components with said same property from the second database table.

22. A data storage arrangement comprising:
a column-type storage arrangement configured and arranged for storing, for each of a plurality of design components, a bit in a column to indicate property characteristics relative to the column for a particular design component for which the bit is stored;
a bit string-type storage arrangement configured and arranged to store a series of bits including series of bits that identify a particular design component and a property name and value for the particular design component; and
a controller configured and arranged to process design property data for selective storage in one or the other of the column-type storage arrangement and the table-type storage arrangement as a function of the type of the design property data.

23. A program storage device, comprising:
a processor-readable medium configured with instructions executable by the processor for demoting a page in virtual memory by performing the operations of:
naming each of a plurality of columns in a relational database table with a property name indicative of a respective one of a plurality of circuit design properties used to characterize at least one of the circuit design components;
naming another column in the relational database table with a property name indicating the column is unassigned to a circuit design property;
naming rows in the relational database table with respective names of the plurality of design components; and
storing property information associated with the plurality of circuit design components in entries of the relational database table, wherein storing includes,
in response to a circuit design component having a property indicated by one of the property names of the columns, storing a data value indicative of the circuit design component having the property, in the table entry at the column having the one of the property names and at the row having the name of the circuit design component; and
in response to a circuit design component not having a property indicated by one of the property names of the columns, storing a data value indicative of the circuit design component having a non-assigned property, in the table entry at the column having the property name indicating the column is unassigned to a circuit design property and at the row having the name of the circuit design component.

24. The device of claim 23, wherein the processor-readable medium is further configured with instructions executable by the processor for demoting a page in virtual memory by performing the operations of, in response to a circuit design component not having a property indicated by one of the property names of the columns, storing data representing the circuit design component name and the property name in a row of a second database table.

25. The device of claim 24, wherein the processor-readable medium is further configured with instructions executable by the processor for demoting a page in virtual memory by performing the operations of storing data representing the circuit design component name and the property name in a row of a second database table by storing a bit string identifying the circuit design component name in the row of the second database table.

26. The device of claim 25, wherein the processor-readable medium is further configured with instructions executable by the processor for demoting a page in virtual memory by performing the operations of storing a bit string identifying the circuit design component name by storing a bit string that references the row, of the relational database, named with the circuit design component.

27. The device of claim 24, wherein the processor-readable medium is further configured with instructions executable by the processor for demoting a page in virtual memory by performing the operations of storing data representing the circuit design component name and the property name in a row of a second database table by storing a bit string identifying the property name in the row of the second database table.

28. The device of claim 24, wherein the processor-readable medium is further configured with instructions executable by the processor for demoting a page in virtual memory by performing the operations of storing data representing a value for the property in the row of the second database table.

29. The device of claim 24, wherein the processor-readable medium is further configured with instructions executable by the processor for demoting a page in virtual memory by performing the operations of storing data representing the circuit design component name and the property name in a row of a second database table by storing the circuit design component name and the property name in a second database table that is separate from the relational database table.

30. The device of claim 23, wherein the processor-readable medium is further configured with instructions executable by the processor for demoting a page in virtual memory by performing the operations of:
storing a data value indicative of the circuit design component having the property by storing a bit that indicates that the circuit design component has the property; and
storing a data value indicative of the circuit design component having a non-assigned property by storing a bit that indicates that the circuit design component has a non-assigned property.

31. The device of claim 23, wherein the processor-readable medium is further configured with instructions executable by the processor for demoting a page in virtual memory by performing the operations of, in response to a circuit design component not having a property indicated by a particular property name of a column, storing a data value indicative of the circuit design component not having the property, in the table entry at the column having the one of the property names and at the row having the name of the circuit design component.

32. The device of claim 31, wherein the processor-readable medium is further configured with instructions executable by the processor for demoting a page in virtual memory by performing the operations of storing a data value indicative of the circuit design component not having the property by storing a bit that indicates that the circuit design component does not have the property.

33. The device of claim 31, wherein the processor-readable medium is further configured with instructions executable by the processor for demoting a page in virtual memory by performing the operations of storing a data value indicative of the circuit design component not having the property by storing a NULL value.

34. The device of claim 23, wherein the processor-readable medium is further configured with instructions executable by the processor for demoting a page in virtual memory by performing the operations of:
monitoring the number of circuit design components having a property named to a column in the relational database; and
removing a property name and all data values from a column as a function of the monitoring.

35. The device of claim 34, wherein the processor-readable medium is further configured with instructions executable by the processor for demoting a page in virtual memory by performing the operations of removing a property name and all data values from a column as a function of the monitoring by removing a property name and all data values from a column when the number of circuit design components that have the property indicated by the property name falls below a selected threshold.

36. The device of claim 35, wherein the processor-readable medium is further configured with instructions executable by the processor for demoting a page in virtual memory by performing the operations of removing a property name and all data values from a column when the number of circuit design components that have the property indicated by the property name falls below a selected threshold by removing the property name and all data values when storing data representing the name of the property and the circuit design components having the property is more efficient than dedicating an entire column to the named property.

37. The device of claim 23, wherein the processor-readable medium is further configured with instructions executable by the processor for demoting a page in virtual memory by performing the operations of:
in response to a circuit design component not having a property indicated by one of the property names of the columns, storing data representing the circuit design component name and the property name in a row of a second database table;
monitoring the number of circuit design components having a property named to a column in the relational database;
removing a property name and all data values from a column as a function of the monitoring; and
for each circuit design component having a property indicated by the removed property name, storing data representing the circuit design component name and the property name in a row of the second database table.

38. The device of claim 37, wherein the processor-readable medium is further configured with instructions executable by the processor for demoting a page in virtual memory by performing the operations of:
monitoring the number of circuit design components having the same property and with data representing the circuit design component name and the property name being stored in a row of the second database table; and
as a function of the monitoring, naming a column in the relational database with said same property and storing a data value indicative of the circuit design components having said same property, in the table entry at the column named with said same property and at respective rows having the name of the circuit design components having said same property, and removing the data representing the circuit design components with said same property from the second database table.

39. The device of claim 23, wherein the processor-readable medium is further configured with instructions executable by the processor for demoting a page in virtual memory by performing the operations of retrieving property data for a particular circuit design component by:
in response to a column in a row named with the circuit design component having a data value indicative of the circuit design component having the property named to the column, returning the property name of the column; and
in response to the column with the property name that indicates the column is unassigned to a circuit design property having, in a row named with the circuit design component, a data value indicative of the circuit design component having an unassigned property, accessing a second database table to retrieve property data, unassigned to a column, for the particular design component.
